(19) United States
(12) Patent Application Publication
(10) Pub. No.: US 2020/0077655 A1
(43) Pub. Date: Mar. 12, 2020

(54) Use of an Acyclic Picolinamide Compound as a Fungicide for Control of Phytopathogenic Fungi in Orchard, Vineyard and Plantation Crops

(71) Applicant: Dow AgroSciences LLC, Indianapolis, IN (US)

(72) Inventors: Valentino Bosco, Lauzacco (IT); Courtney Gallup, Davenport, IA (US); Alisa Ye Yu, Shanghai (CN); Luis Claudio Vieira Da Cunha, Sau Paulo City (BR); Alejandro Cedeno Ramirez, Cartago (CR); John Richburg, Headland, AL (US); Alejandro Calixto, Wesley Chapel, FL (US); Marsha Martin, Columbus, OH (US); Alistair McKay, Clovis, CA (US)

(73) Assignee: Dow AgroSciences LLC, Indianapolis, IN (US)

(21) Appl. No.: 16/610,102

(22) PCT Filed: May 2, 2018
(86) PCT No.: PCT/US2018/030555

§ 371 Date: Nov. 1, 2019

Related U.S. Application Data
(60) Provisional application No. 62/500,175, filed on May 2, 2017.

(51) Int. Cl. A01N 43/40

(52) U.S. Cl. CPC A01N 43/40

(57) ABSTRACT

The present disclosure is related to the field of agrochemicals, including compound I and its use to control fungal diseases in agriculturally useful orchard, vineyard and plantation crops.

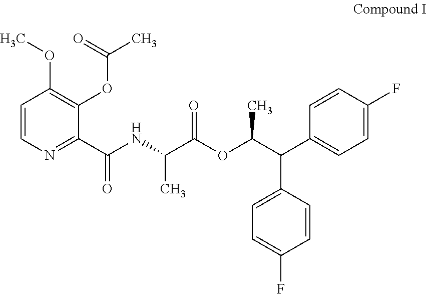 [SMILES: COc1ccnc(C(=O)N[C@@H](C)C(=O)O[C@@H](C)C(c2ccc(F)cc2)c2ccc(F)cc2)c1OC(C)=O]

### CROSS-REFERENCE TO RELATED APPLICATIONS

This is a national phase entry under 35 U.S.C. § 371 of international patent application PCT/US18/030555, filed on May 2, 2018 and published in English as international patent publication WO2018204433 on Nov. 8, 2018, which claims the benefit of U.S. Provisional Patent Application Ser. No. 62/500,175 filed May 2, 2017, which is expressly incorporated by reference herein.

### FIELD

This present disclosure is related to the field of the use of (S)-1,1-bis(4-fluorophenyl)propan-2-yl (3-acetoxy-4-methoxypicolinoyl)-L-alaninate to control fungal diseases in orchard, vineyard and plantation crops.

### BACKGROUND AND SUMMARY

Fungicides are compounds, of natural or synthetic origin, which act to protect and cure plants against damage caused by agriculturally-relevant fungi. Generally, no single fungicide is useful in all situations. Consequently, research is ongoing to produce fungicides that may have better performance, are easier to use, and cost less. The present disclosure relates to (S)-1,1-bis(4-fluorophenyl)propan-2-yl (3-acetoxy-4-methoxypicolinoyl)-L-alaninate (compound I) and its use as a fungicide. Compound I may offer protection against ascomycetes, basidiomycetes, and deuteromycetes.

One embodiment of the present disclosure includes a method of controlling a pathogen-induced disease in a plant that is at risk of being diseased from the pathogen comprising contacting the plant or an area adjacent to the plant with a composition including compound I.

Another embodiment of the present disclosure is a use of compound I for protection of a plant against attack by a phytopathogenic organism or the treatment of a plant infested by a phytopathogenic organism, comprising the application of compound I, or a composition including compound I to soil, a plant, a part of a plant, foliage, and/or seeds.

Additionally, another embodiment of the present disclosure is a composition useful for protecting a plant against attack by a phytopathogenic organism and/or treatment of a plant infested by a phytopathogenic organism comprising compound I and a phytologically acceptable carrier material.

### DETAILED DESCRIPTION

One exemplary embodiment of the present disclosure includes mixtures for controlling the growth of fungi, the mixture including compound I:

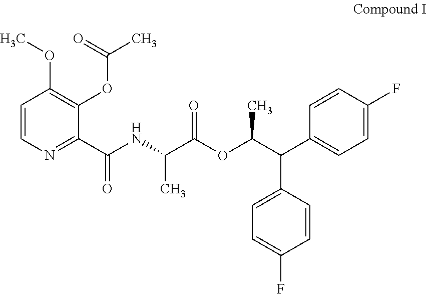 [SMILES: COc1ccnc(C(=O)N[C@@H](C)C(=O)O[C@@H](C)C(c2ccc(F)cc2)c2ccc(F)cc2)c1OC(C)=O]

Compound I of the present disclosure may be applied by any of a variety of known techniques, either as compound I or as formulations comprising compound I. For example, compound I may be applied to the roots, stems, seeds, flowers, or foliage of plants for the control of various fungi, without damaging the commercial value of the plants. Compound I may also be applied as a foliar spray, chemigation, soil drench, soil injection, soil spray, soil incorporation, or seed treatment. The material may be applied in the form of any of the generally used formulation types, for example, as solutions, dusts, wettable powders, flowable concentrates, or emulsifiable concentrates.

Preferably, compound I of the present disclosure is applied in the form of a formulation, including compound I with a phytologically acceptable carrier. Concentrated formulations may be dispersed in water or other liquids for application, or formulations may be dust-like or granular, which may then be applied without further treatment. The formulations can be prepared according to procedures that are conventional in the agricultural chemical art.

The present disclosure contemplates all vehicles by which compound I may be formulated for delivery and use as a fungicide. Typically, formulations are applied as aqueous suspensions or emulsions. Such suspensions or emulsions may be produced from water-soluble, water-suspendible, or emulsifiable formulations which are solids, usually known as wettable powders; or liquids, usually known as emulsifiable concentrates, aqueous suspensions, or suspension concentrates. As will be readily appreciated, any material to which compound I may be added may be used, provided it yields the desired utility without significant interference with the activity of compound I as an antifungal agent.

Wettable powders, which may be compacted to form water-dispersible granules, comprise an intimate mixture including compound I, an inert carrier and surfactants. The concentration of compound I in the wettable powder may be from about 10 percent to about 90 percent by weight based on the total weight of the wettable powder, more preferably about 25 weight percent to about 75 weight percent. In the preparation of wettable powder formulations, compound I may be compounded with any finely divided solid, such as prophyllite, talc, chalk, gypsum, Fuller's earth, bentonite, attapulgite, starch, casein, gluten, montmorillonite clays, diatomaceous earths, purified silicates or the like. In such operations, the finely divided carrier and surfactants are typically blended with compound I and milled.

Emulsifiable concentrates of compound I may comprise a convenient concentration, such as from about 10 weight percent to about 50 weight percent of compound I, in a suitable liquid, based on the total weight of the concentrate. Compound I may be dissolved in an inert carrier, which is either a water-miscible solvent or a mixture of water-immiscible organic solvents, and emulsifiers. The concentrates may be diluted with water and oil to form spray mixtures in the form of oil-in-water emulsions. Useful organic solvents include aromatics, especially the high-boiling naphthalenic and olefinic portions of petroleum, such as heavy aromatic naphtha. Other organic solvents may also be used, for example, terpenic solvents, including rosin derivatives, aliphatic ketones, such as cyclohexanone, and complex alcohols, such as 2-ethoxyethanol.

Emulsifiers which may be advantageously employed herein may be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulphonic acids, oil-soluble salts or sulfated polyglycol ethers and appropriate salts of phosphated polyglycol ether.

Representative organic liquids which may be employed in preparing the emulsifiable concentrates of compound I of the present invention are the aromatic liquids such as xylene, propyl benzene fractions; or mixed naphthalene fractions, mineral oils, substituted aromatic organic liquids such as dioctyl phthalate; kerosene; dialkyl amides of various fatty acids, particularly the dimethyl amides of fatty glycols and glycol derivatives such as the n-butyl ether, ethyl ether or methyl ether of diethylene glycol, and the methyl ether of triethylene glycol and the like. Mixtures of two or more organic liquids may also be employed in the preparation of the emulsifiable concentrate. Organic liquids include xylene, and propyl benzene fractions, with xylene being most preferred in some cases. Surface-active dispersing agents are typically employed in liquid formulations and in an amount of from 0.1 to 20 percent by weight based on the combined weight of the dispersing agent with compound I. The formulations can also contain other compatible additives, for example, plant growth regulators and other biologically active compounds used in agriculture.

Aqueous suspensions including compound I may be dispersed in an aqueous vehicle at a concentration in the range from about 5 to about 50 weight percent, based on the total weight of the aqueous suspension. Suspensions are prepared by finely grinding compound I, and vigorously mixing the ground material into a vehicle comprised of water and surfactants chosen from the same types discussed above. Other components, such as inorganic salts and synthetic or natural gums, may also be added to increase the density and viscosity of the aqueous vehicle.

Compound I may also be applied as a granular formulation, which is particularly useful for applications to the soil. Granular formulations generally contain from about 0.5 to about 10 weight percent, based on the total weight of the granular formulation of compound I, dispersed in an inert carrier which consists entirely or in large part of coarsely divided inert material such as attapulgite, bentonite, diatomite, clay or a similar inexpensive substance. Such formulations are usually prepared by dissolving compound I in a suitable solvent and applying it to a granular carrier which has been preformed to the appropriate particle size, in the range of from about 0.5 to about 3 mm. A suitable solvent is a solvent in which compound I is substantially or completely soluble. Such formulations may also be prepared by making a dough or paste of the carrier and compound I and solvent, and crushing and drying to obtain the desired granular particle.

Dusts containing compound I may be prepared by intimately mixing compound I in powdered form with a suitable dusty agricultural carrier, such as, for example, kaolin clay, ground volcanic rock, and the like. Dusts can suitably contain from about 1 to about 10 weight percent of compound I, based on the total weight of the dust.

The formulations may additionally contain adjuvant surfactants to enhance deposition, wetting and penetration of compound I onto the target crop and organism. These adjuvant surfactants may optionally be employed as a component of the formulation or as a tank mix. The amount of adjuvant surfactant will typically vary from 0.01 to 1.0 percent by volume, based on a spray-volume of water, preferably 0.05 to 0.5 volume percent. Suitable adjuvant surfactants include, but are not limited to ethoxylated nonyl phenols, ethoxylated synthetic or natural alcohols, salts of the esters or sulphosuccinic acids, ethoxylated organosilicones, ethoxylated fatty amines and blends of surfactants with mineral or vegetable oils. The formulations may also include oil-in-water emulsions such as those disclosed in U.S. patent application Ser. No. 11/495,228, the disclosure of which is expressly incorporated by reference herein.

In certain instances, it would be beneficial for formulations of compound I to be sprayed via an aerial application using aircraft or helicopters. The exact components of these aerial applications depends upon the crop being treated. Aerial applications for cereals utilize spray volumes preferably from 15 to 50 L/ha with standard spreading or penetrating type adjuvants such as non-ionic surfactants, organosilicones, or crop oils, preferably from 0.05 to 15 percent, based on a spray volume of water. Aerial applications for fruit bearing crops, such as bananas, may utilize lower application volumes with higher adjuvant concentrations, preferably in the form of sticker adjuvants, such as fatty acids, latex, aliphatic alcohols, crop oils and inorganic oils. Typical spray volumes for fruit bearing crops are preferably from 15 to 30 L/ha with adjuvant concentrations reaching up to 30% based on a spray volume of water. A typical example might include, but not limited to, an application volume of 23 L/ha, with a 30% paraffin oil sticker adjuvant concentration (e.g. Spraytex CT).

The formulations may optionally include combinations that contain other pesticidal compounds. Such additional pesticidal compounds may be fungicides, insecticides, herbicides, nematicides, miticides, arthropodicides, bactericides or combinations thereof that are compatible with the compounds of the present invention in the medium selected for application, and not antagonistic to the activity of the present compounds. Accordingly, in such embodiments, the other pesticidal compound is employed as a supplemental toxicant for the same or for a different pesticidal use. Compound I and the pesticidal compound in the combination can generally be present in a weight ratio of from 1:100 to100:1.

Compound I of the present disclosure may also be combined with other fungicides to form fungicidal mixtures and synergistic mixtures thereof. Compound I of the present disclosure is often applied in conjunction with one or more other fungicides to control a wider variety of undesirable diseases. When used in conjunction with other fungicide(s), the presently claimed compound I may be formulated with the other fungicide(s), tank-mixed with the other fungicide(s) or applied sequentially with the other fungicide(s). Such other fungicides may include 2-(thiocyanatomethylthio)-benzothiazole, 2-phenylphenol, 8-hydroxyquinoline sulfate, ametoctradin, amisulbrom, antimycin, Ampelomyces quisqualis, azaconazole, azoxystrobin, Bacillus subtilis, Bacillus subtilis strain QST713, benalaxyl, benomyl, benthiavalicarb-isopropyl, benzylaminobenzene-sulfonate (BAB S) salt, bicarbonates, biphenyl, bismerthiazol, bitertanol, bixafen, blasticidin-S, borax, Bordeaux mixture, boscalid, bromuconazole, bupirimate, calcium polysulfide, captafol, captan, carbendazim, carboxin, carpropamid, carvone, chlazafenone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, enestrobin, enestroburin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), iodocarb, ipconazole, ipfenpyrazolone, iprobenfos, iprodione, iprovalicarb, isoprothiolane, isopyrazam, isotianil, kasugamycin, kasugamycin hydrochloride hydrate, kresoxim-methyl, laminarin, mancopper, mancozeb, mandipropamid, maneb, mefenoxam, mepanipyrim, mepronil, meptyl-dinocap, mercuric chloride, mercuric oxide, mercurous chloride, metalaxyl, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrametostrobin, pyraoxystrobin, pyrazophos, pyribencarb, pyributicarb, pyrifenox, pyrimethanil, pyriofenone, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triphenyltin hydroxide, triticonazole, validamycin, valifenalate, valiphenal, vinclozolin, zineb, ziram, zoxamide, Candida oleophila, Fusarium oxysporum, Gliocladium spp., Phlebiopsis gigantea, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme, aminopyrifen, ampropylfos, anilazine, azithiram, barium polysulfide, Bayer 32394, benodanil, benquinox, bentaluron, benzamacril; benzamacril-isobutyl, benzamorf, benzovindiflupyr, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, coumoxystrobin, cufraneb, cupric hydrazinium sulfate, cuprobam, cyclafuramid, cypendazole, cyprofuram, decafentin, dichlobentiazox, dichlone, dichlozoline, diclobutrazol, dimethirimol, dinocton, dinosulfon, dinoterbon, dipymetitrone, dipyrithione, ditalimfos, dodicin, drazoxolon, EBP, enoxastrobin, ESBP, etaconazole, etem, ethirim, fenaminosulf, fenaminstrobin, fenapanil, fenitropan, fenpicoxamid, fluindapyr, fluopimomide, fluotrimazole, flufenoxystrobin, furcarbanil, furconazole, furconazole-cis, furmecyclox, furophanate, glyodine, griseofulvin, halacrinate, Hercules 3944, hexylthiofos, ICIA0858, inpyrfluxam, ipfentrifluconazole, ipflufenoquin, isofetamid, isoflucypram, isopamphos, isovaledione, mandestrobin, mebenil, mecarbinzid, mefentrifluconazole, metazoxolon, methfuroxam, methylmercury dicyandiamide, metsulfovax, metyltetraprole, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, oxathiapiprolin, phenylmercury dimethyldithiocarbamate, phenylmercury nitrate, phosdiphen, picarbutrazox, prothiocarb; prothiocarb hydrochloride, pydiflumetofen, pyracarbolid, pyrapropoyne, pyraziflumid, pyridachlometyl, pyridinitril, pyrisoxazole, pyroxychlor, pyroxyfur, quinacetol, quinacetol sulfate, quinazamid, quinconazole, quinofumelin, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, triclopyricarb, triflumezopyrim, urbacid, zarilamid, and any combinations thereof.

Additionally, compound I of the present invention may be combined with other pesticides, including insecticides, nematicides, miticides, arthropodicides, bactericides or combinations thereof that are compatible with compound I of the present invention in the medium selected for application, and not antagonistic to the activity of compound I, to form pesticidal mixtures and synergistic mixtures thereof. Compound I of the present disclosure may be applied in conjunction with one or more other pesticides to control a wider variety of undesirable pests. When used in conjunction with other pesticides, the presently claimed compound I may be formulated with the other pesticide(s), tank mixed with the other pesticide(s) or applied sequentially with the other pesticide(s). Typical insecticides include, but are not limited to: antibiotic insecticides such as allosamidin and thuringiensin; macrocyclic lactone insecticides such as spinosad and spinetoram; avermectin insecticides such as abamectin, doramectin, emamectin, eprinomectin, ivermectin and selamectin; milbemycin insecticides such as lepimectin, milbemectin, milbemycin oxime and moxidectin; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dessicant insecticides such as boric acid, diatomaceous earth and silica gel; diamide insecticides such as broflanilide, chlorantraniliprole, cyantraniliprole, cyclaniliprole, cyhalodiamide, flubendiamide, tetrachlorantraniliprole, and tetraniliprole; diarylisoxazoline insecticides such as fluxametamide; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; mesoionic insecticides such as dicloromezotiaz and triflumezopyrim; moulting hormone agonists such as chromafenozide, halofenozide, methoxyfenozide and tebufenozide; moulting hormones such as α-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; pyridylpyrazole insecticides such as tyclopyrazoflor; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethyl-amine insecticides such as acetamiprid, cycloxaprid, imidacloprid, nitenpyram, and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, alpha-endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, j odfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, isofenphos-methyl, methamidophos and propetamphos; phosphorodiamide insecticides such as dimefox, mazidox, mipafox and schradan; oxadiazine insecticides such as indoxacarb; oxadiazoline insecticides such as metoxadiazone; phthalimide insecticides such as dialifos, phosmet and tetramethrin; pyrazole insecticides such as tebufenpyrad, tolefenpyrad; phenylpyrazole insecticides such as acetoprole, ethiprole, fipronil, pyrafluprole, pyriprole and vaniliprole; pyrethroid ester insecticides such as acrinathrin, allethrin, bioallethrin, barthrin, bifenthrin, kappa-bifenthrin, bioethanomethrin, chloroprallethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, heptafluthrin, imiprothrin, meperfluthrin, metofluthrin, epsilon-metofluthrin, momfluorothrin, epsilon-momfluorothrin, permethrin, biopermethrin, transpermethrin, phenothrin, prallethrin, profluthrin, pyresmethrin, resmethrin, bioresmethrin, cismethrin, tefluthrin, kappa-tefluthrin, terallethrin, tetramethrin, tetramethylfluthrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetramic acid insecticides such as spiropidion and spirotetramat; tetronic acid insecticides such as spiromesifen; thiourea insecticides such as diafenthiuron; urea insecticides such as flucofuron and sulcofuron; unclassified nematicides such as fluazaindolizine and tioxazafen; and unclassified insecticides such as benzpyrimoxan, closantel, copper naphthenate, crotamiton, EXD, fenazaflor, fenoxacrim, fluhexafon, flupyrimin, hydramethylnon, isoprothiolane, malonoben, metaflumizone, nifluridide, oxazolsulfyl, plifenate, pyridaben, pyridalyl, pyrifluquinazon, rafoxanide, sulfoxaflor, triarathene and triazamate, and any combinations thereof.

Additionally, compound I of the present invention may be combined with herbicides that are compatible with compound I of the present invention in the medium selected for application, and not antagonistic to the activity of compound I to form pesticidal mixtures and synergistic mixtures thereof. The fungicidal compound I of the present disclosure may be applied in conjunction with one or more herbicides to control a wide variety of undesirable plants. When used in conjunction with herbicides, the presently claimed compound I may be formulated with the herbicide(s), tank mixed with the herbicide(s) or applied sequentially with the herbicide(s). Typical herbicides include, but are not limited to: amide herbicides such as allidochlor, beflubutamid, benzadox, benzipram, bromobutide, cafenstrole, CDEA, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid, tebutam and tiafenacil; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides such as benzofluor, perfluidone, pyrimisulfan and profluazol; sulfonamide herbicides such as asulam, carbasulam, fenasulam and oryzalin; thioamide herbicides such as chlorthiamid; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid, florpyrauxifen, halauxifen, and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as fenquinotrione, lancotrione, mesotrione, sulcotrione, tefuryltrione and tembotrione; benzofuranyl alkylsulfonate herbicides such as benfuresate and ethofumesate; benzothiazole herbicides such as benzazolin; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrile herbicides such as bromobonil, bromoxynil, chloroxynil, cyclopyranil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glufosinate-P, glyphosate and piperophos; phenoxy herbicides such as bromofenoxim, clomeprop, 2,4-DEB, 2,4-DEP, difenopenten, disul, erbon, etnipromid, fenteracol and trifopsime; oxadiazoline herbicides such as methazole, oxadiargyl, oxadiazon; oxazole herbicides such as fenoxasulfone; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazole herbicides such as pyroxasulfone; benzoylpyrazole herbicides such as benzofenap, pyrasulfotole, pyrazolynate, pyrazoxyfen, tolpyralate, and topramezone; phenylpyrazole herbicides such as fluazolate, nipyraclofen, pioxaden and pyraflufen; pyridazine herbicides such as credazine, cyclopyrimorate, pyridafol and pyridate; pyridazinone herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, florpyrauxifen, fluroxypyr, halauxifen, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, indaziflam, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron, metribuzin, and trifludimoxazin; triazole herbicides such as amitrole, cafenstrole, epronaz and flupoxam; triazolone herbicides such as amicarbazone, bencarbazone, carfentrazone, flucarbazone, ipfencarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as benzfendizone, bromacil, butafenacil, flupropacil, isocil, lenacil, saflufenacil and terbacil; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, nicosulfuron, orthosulfamuron, oxasulfuron, primisulfuron, propyrisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, iofensulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluron and thidiazuron; and unclassified herbicides such as acrolein, allyl alcohol, aminocyclopyrachlor, azafenidin, bentazone, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, cyclopyrimorate, ortho-dichlorobenzene, dimepiperate, endothal, fluoromidine, fluridone, flurochloridone, flurtamone, fluthiacet, indanofan, methyl isothiocyanate, OCH, oxaziclomefone, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan and tritac.

Compound I of the present invention can also comprise or may be applied together and/or sequentially with further active compounds. These further compounds can be plant health stimulants, such as organic compounds, inorganic fertilizers, or micronutrient donors or other preparations that influence plant growth, such as inoculants.

In another embodiment, Compound I can also comprise or may be applied together and/or sequentially with other biological organisms, such as, but not limited to the group consisting of Bacillus strains, for example Bacillus subtilis var. amyloiquefaciens FZB24 (TAEGRP®) and Bacillus amyloiquefaciens FZB42 (RHIZOVITAL®), VotiVo™ Bacillus firmus, Clariva™ (Pasteuria nishizawae), Bacillus thuringiensis, Trichoderma spp., and/or mutants and metabolites of the respective strains that exhibit activity against insects, mites, nematodes, and/or phytopathogens.

One embodiment of the present disclosure is a method for the control or prevention of fungal attack. This method comprises applying to the soil, plant, roots, foliage, seed or locus of the fungus, or to a locus in which the infestation is to be prevented (for example applying to cereal or grape plants), a fungicidal effective amount of compound I. Compound I is suitable for treatment of various plants at fungicidal levels, while exhibiting low phytotoxicity. Compound I may be useful both in a protectant and/or an eradicant fashion.

The compound of Formula I has been found to have significant fungicidal effects particularly for agricultural use. The compound of Formula I is particularly effective for use with agricultural crops and horticultural plants. Additional benefits may include, but are not limited to, improving the health of a plant; improving the yield of a plant (e.g. increased biomass and/or increased content of valuable ingredients); improving the vigor of a plant (e.g. improved plant growth and/or greener leaves); improving the quality of a plant (e.g. improved content or composition of certain ingredients); and improving the tolerance to abiotic and/or biotic stress of the plant.

In particular, the composition is effective in controlling a variety of undesirable fungi that infect useful orchard, vineyard and plantation crops. The composition may be used against a variety of Ascomycete and Basidiomycete fungi, including, for example, the following representative fungi species:

On stone and pome fruits: leaf spot (Mycosphaerella cersella, Mycosphaerella pyri, Cercospora rubrotincta), anthracnose (Glomerella cingulata, Glomerella acutata), leaf spot of cherry (Blumeriella jaapii), powdery mildew (Podosphaeria leucotricha, Podosphaeria pannosa), Alternaria rot/black spot (Alternaria alternata, A. gaisen), gummosis (Botryosphaeria spp.), fruit rot (Botrytis cinerea), scab (Venturia thequalis, V. pirinia, V. carpophila, V. nashicola, Venturia spp.), southern blight (Sclerotium rolfsii), black rot (Botryosphaeria obtusa), Alternaria blotch and rot (Alternaria mali, Alternaria spp.), cedar apple rust (Gymnosporangium juniper-virginianae), American hawthorn rust (Gymnosporagium globosum), Japanese pear rust (Gymnosporangium asiaticum), European pear rust (Gymnosporangium sabinae), Kern's pear rust (Gymnosporangium kernianum), pacific coast pear rust (Gymnosporangium libocedri), Rocky Mountain pear rust (Gymnosporangium nelsoni), bitter rot (Colletotrichum spp.), white rot (Botryosphaeria dothidea), black rot (Diplodia seriata), sooty blotch and flyspeck (pathogen complex including Dothideomycetes and Sordariomycetes), Fabraea leaf spot (Fabraea maculata, Diplocarpon mespili), brown spot (Stemphylium vesicarium), Brooks fruit spot (Mycosphaerella pomi), Phoma leaf and fruit spot (Phoma spp.), blotch (Phyllosticta solitaria), black pox and blister canker (Ellisembia asterinum), apple ring spot (Botryosphaeria spp.), calyx-end rot (Sclerotinia sclerotiorum), Monilinia leaf blight and brown rot (Monilinia spp.), Marssonina blotch (Diplocarpon mali), blue mold (Penicillium spp.), gray mold (Botrytis cinerea), and canker and wood rot diseases (Neonectria spp., Neofabraea spp., Diaporthe spp., Valsa spp., Botryosphaeria spp., Armilllaria spp., Chondrostereum spp., Schizophylum spp., Stereum spp., Trametes spp.);

On grapes: black rot (Guignardia bidwellii, Phyllosticta ampelicida), bitter rot (Greeneria uvicola), Eutypa dieback (Eutypa lata), Botryosphaeria dieback and Macrophoma rot (Botryosphaeria spp.), Botrytis bunch rot and blight (Botrytis cinerea), Phomopsis cane and leaf spot (Phomopsis viticola, Cryptosporella viticola), Rotbrenner (Pseudopezicula trachelphila, Pseudopeziza trachelphila), anthracnose (Elsinoe ampelina), rust (Phakopsora ampelopsidis, Phakopsora euvitis), Septoria leaf spot (Septoria ampelina), leaf blight (Pseudocercospora vitis), leaf blotch (Briosia ampelophaga), powdery mildew (Erysiphe necator), white rot (Coniella diplodiella Pilidiella diplodiella), ripe rot (Colletotrichum spp.), berry rots and molds (Alternaria spp., Cladosporium spp., Botrytis cinerea, Colletotrichum spp., Diplodia spp., Greeneria spp., Phomopsis spp., Aspergillus spp., Penicillium spp., Rhizopus spp., Fusarium spp., Stemphyilium spp., Ascochyta spp.);

On strawberries: Septoria hard rot and leaf spot (Septoria spp.), powdery mildew (Sphaerotheca macularis, Podosphaera macularis), anthracnose (Colletotrichum spp.), common leaf spot (Mycosphaerella fragariae), Cercospora leaf spot (Cercospora spp.), leaf rust (Phragmidium potentillae, Frommeella tormentillae), Sclerotinia crown and fruit rot (Sclerotinia sclerotiorum), Alternaria fruit rot and black leaf spot (Alternaria spp.), anther and pistil blight/black root rot/hard brown rot (Rhizoctonia spp.), charcoal rot (Macrophomina phaseolina), Coniothyrium diseases (Coniothyrium fuckelii, Coniella fragariae), Dematophora crown and root rot/white root rot (Rosellinia necatrix), Diplodina rot/leaf and stalk rot (Phoma lycopersici), fruit rots (Aspergillus niger, Cladosporium spp., Penicillium spp.), Byssochlamys rot (Byssochlamys fulva), Fruit blotch (Peronospora potentillae, Sphaeropsis malorum, Sclerotium rolfsii, Schizoparme straminea), Gray mold leaf blight and dry crown rot (Botrytis cinerea), leaf scorch (Diplocarpon earlianum), Pestalotia fruit rot (Pestalotia sp.), Leaf blight (Phomopsis obscurans), Postharvest rots (Botrytis cinerea, Pichia spp., Saccharomyces spp.), southern blight (Sclerotium rolfsii);

On bananas: Anthracnose (Colletotrichum musae, Armillaria corn rot (Armillaria mellea, Armillaria tabescens), Black cross (Phyllachora musicola), Black root rot (Rosellinia bunodes), Black Sigatoka (Mycosphaerella fijiensis), Brown blotch (Pestalotiopsis leprogena), Brown spot (Cercospora hayi), Ceratocystis fruit rot (Ceratocystis paradoxa), Cigar-end (Verticillium theobromae, Trachysphaera fructigena), Cladosporium speckle (Cladosporium musae), Corm dry rot (Junghuhnia vincta), Cordana leaf spot (Cordana johnstonii, Cordana musae), Crown rot (Colletotrichum musae, Verticillium theobromae, Fusarium spp., Acremonium spp.), Cylindrocladium root rot (Cylindrocladium spp.), Deightoniella fruit speckle, damping off, leaf spot and tip rot (Deightoniella torulosa), Diamond spot (Cercospora hayi, Fusarium spp.), Dwarf Cavendish tip rot (Nattrassia mangiferae), Eyespot (Drechslera gigantean), Fruit freckle (Guignardia musae), Fruit rot (Botryosphaeria ribis), Fungal root-rot (Fusarium spp., Rhizoctonia spp.), Fungal scald (Colletotrichum musae), Leaf rust (Uredo musae, Uromyces musae), Leaf speckle (Acrodontium simplex), Leaf spot (Curvularia eragrostidis, Drechslera musae-sapientum, Leptosphaeria musarum, Pestalotiopsis disseminata), Main stalk rot (Ceratocystis paradoxa), Malayan leaf spot (Haplobasidion musae), Marasmiellus rot (Marasmiellus inoderma), Panama disease (Fusarium oxysporum f. sp. cubense), Peduncle rot (Lasiodiplodia theobromae, Fusarium spp., Verticillium theobromae), Pestalotiopsis leaf spot (Pestalotiopsis palmarum), Phaeoseptoria leaf spot (Phaeoseptoria musae), Pitting (Pyricularia grisea), Pseudostem heart rot (Fusarium moniliforme), Root & rhizome rot (Cylindrocarpon musae), Sclerotinia fruit rot (Sclerotinia sclerotiorum), Septoria leaf spot (Septoria eumusae), Sheath rot (Nectria foliicola, Mycosphaerella musicola), Sooty mold (Limacinula tenuis), Speckle (Mycosphaerella musae), Black end disease (Nigrospora sphaerica), Stem-end rot (Colletotrichum musae), Tropical speckle (Ramichloridium musae), Verticillium tip rot (Verticillium theobromae), and Yellow Sigatoka (Mycosphaerella musicola).

Compound I has been found to have significant fungicidal effects on phytopathogenic fungi of agriculturally useful orchard, vineyard and plantation crops. These diseases include Monilinia laxa and Monilinia fructicola, which causes brown rot of flowers and fruits of stone fruits; Rhizopus stolonifera, which causes fruit rot of stone fruits; Podosphaera leucotricha, which causes powdery mildew of apples; Alternaria mali, which causes leaf spot of apples; Venturia pyrina, which causes scab of pear; Capnodium spp., which causes sooty mold of pear; Erysiphe necator, which causes powdery mildew of grape; Botrytis cinerea, which causes gray mold of strawberry and grapevine, and Mycosphaerella fijiensis, which causes black sigatoka of bananas, particularly for agricultural use. Compound I is particularly effective for use with agricultural crops and horticultural plants.

Compound I has a broad range of efficacy as a fungicide. The exact amount of the active material to be applied is dependent not only on the specific active material being applied, but also on the particular action desired, the fungal species to be controlled, and the stage of growth thereof, as well as the part of the plant or other product to be contacted with the compound. Thus, compound I, and formulations containing the same, may not be equally effective at similar concentrations or against the same fungal species.

Compound I is effective in use with plants in a disease-inhibiting and phytologically acceptable amount. The term “disease-inhibiting and phytologically acceptable amount” refers to an amount of a compound that kills or inhibits the plant disease for which control is desired, but is not significantly toxic to the plant. This amount will generally be from about 0.1 to about 1000 ppm (parts per million), with 1 to 500 ppm being preferred. The exact concentration of compound required varies with the fungal disease to be controlled, the type of formulation employed, the method of application, the particular plant species, climate conditions, and the like. A suitable application rate is typically in the range from about 0.10 to about 4 pounds/acre (about 0.01 to 0.45 grams per square meter, g/m²).

Any range or desired value given herein may be extended or altered without losing the effects sought, as is apparent to the skilled person for an understanding of the teachings herein.

### EXAMPLES

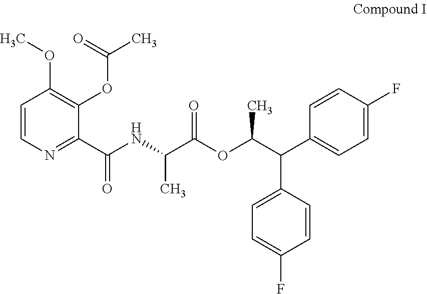 [SMILES: COc1ccnc(C(=O)N[C@@H](C)C(=O)O[C@@H](C)C(c2ccc(F)cc2)c2ccc(F)cc2)c1OC(C)=O]

Field Assessment of Compound I on Brown Rot of Flowers (MONILA, Monilinia laxa) in Stone Fruits:

A fungicidal treatment containing Compound I, applied in a 5% EC formulation and tank mixed with an adjuvant (Trycol, 50% w/w at 0.2% v/v), was sprayed twice during the flowering period on the plant canopy of apricots (PRNAR, Protici variety) at rates of 50, 100, and 150 grams of active ingredient per hectare (g ai/ha). The applications were done at 7 day intervals with disease inoculation at the last application (protectant). The treatment was part of an experimental trial designed as a randomized complete block with four replications and a plot of approximately 4.7×3.1 m, with compound I being applied using a MISTBLOW, Solo backpack applicator at a water volume of 500 L/ha.

MONILA disease was evaluated on flowers on a sample of 10 pre-marked branches per tree. The number of infected flowers was counted and consequently the percent incidence was calculated. Visual infection was assessed three times during the trial at 10, 14 and 20 days after the second application. Area under the disease progress curve (AUDPC) was calculated for each plot using the sets of recorded severity data. Relative AUDPC (% control based on AUDPC) was calculated as percent of the nontreated control. Results are given in Table 1.

Field Assessment of Compound I on Brown Rot of Fruits (MONIFC, Monilinia fructicola) on Stone Fruits:

A fungicidal treatment containing Compound I, applied in a 5% EC formulation and tank mixed with an adjuvant (Trycol, 50% w/w at 0.2% v/v), was sprayed twice during fruit ripening on the plant canopy of nectarines (PRNPN, Calfornia variety) at rates of 50, 100, and 150 grams of active ingredient per hectare (g ai/ha). The applications were done at 8 day intervals with disease inoculation 12 days before the first application (curative). The treatment was part of an experimental trial designed as a randomized complete block with four replications and a plot of approximately 4.3×6.0 m, with compound I being applied using a MISTBLOW, Solo backpack applicator at a water volume of 800 L/ha.

The pathogen was certified to be Monilinia fructicola (MONIFC) by means of an immunoassay followed by a PCR assay on material collected (mummies) from the trial. The brown rot disease at harvest was evaluated on 100 randomly picked fruits per plot, 8 days after application B (8 DAAB), calculating the incidence of fruit with disease and then the percent control using Abbotts. Visually healthy samples of 60 fruits per plot were then placed in alveolus plates and kept for 5 days in cold storage. The samples were then maintained for 14 days at about 20° C. (shelf life period). Several assessments were made to check the development of disease during the shelf life simulation. In particular, the percentage of rotten fruits were checked at the exit from cold storage (after 5 days of refrigeration, 13 DAAB) followed by 15, 17, 20 and 23 DAAB. Percent of fruit with disease was calculated (incidence) amd then percent control was calculated using Abbotts. Harvest and shelf life simulation results are given in Table 2.

Field Assessment of Compound I on Brown Rot (MONIFC, Monilinia fructicola) and Rhizopus Rot (RIZPST, Rhizopus stolonifer) on Apricots:

A field trial assessing the utility of Compound I on rot diseases of stone fruits was done using apricots in a microplot method, part of an experimental trial designed as a randomized complete block with four replications. In a microplot method, two mature fruits on a single branch or cluster of fruits were selected for each replication (for a total of 10 replications) instead of using an entire replication. Colored flagging identified treatments. Fungicidal treatments containing Compound I, applied in a 5% EC formulation and tank mixed with an adjuvant (Trycol, 50% w/w at 0.2% v/v), were sprayed on apricots (PRNAR) at rates of 50, 100, and 150 grams of active ingredient per hectare (g ai/ha). The applications to the selected mature apricots were done at 7 days before harvest using a hand held manual spray bottle at a water volume of 500 L/ha. One day after application, a ZipLoc plastic bag was placed over the fruit or fruit cluster and an inoculation mix of MONIFC (Rhizopus was from natural population present in the orchard) was sprayed inside covering the fruits. The plastic bags were removed after 24 hours. At harvest, the fruits were collected in the field and placed in plastic Tupperware containers. 150 mL of de-ionized water was poured in the bottom of the Tupperware containers and the fruits were sprayed with a light mist of water. The containers were brought to the lab, enclosed in a large trash bag to keep the humidity high, and incubated on a lab bench at approximately 23° C. Visual disease incidence was assessed during the trial at 9 and 16 days after application. Area under the disease progress curve (AUDPC) was calculated for each plot using the sets of recorded incidence data. Relative AUDPC (% control based on AUDPC) was calculated as percent of the nontreated control. Results are given in Table 3.

Field Assessment of Compound I on Brown Rot (MONIFC, Monilinia fructicola) and Rhizopus Rot (RIZPST, Rhizopus stolonifer) on Peaches:

A field trial assessing the utility of Compound I on rot diseases of stone fruits was also done on peaches using a microplot method, part of an experimental trial designed as a randomized complete block with four replications. In a microplot method, two mature fruits on a single branch or cluster of fruits were selected for each replication (for a total of 10 replications) instead of using an entire replication. Colored flagging identified treatments. One day before the first application, a ZipLoc plastic bag was placed over the fruit or fruit cluster and an inoculation mix of MONIFC was sprayed inside covering the fruits. The plastic bags were removed after 24 hours. After 24 hr, fungicidal treatments containing Compound I, applied in a 5% EC formulation and tank mixed with an adjuvant (Trycol, 50% w/w at 0.2% v/v), were then sprayed twice on peaches (PRNPS) at rates of 50, 100, and 150 grams of active ingredient per hectare (g ai/ha). The applications to the selected mature peaches were done at 14 and 7 days before harvest using a CO2 powered inoculation spray gun at a water volume of 500 L/ha. At harvest, the fruits were collected in the field and placed in plastic Tupperware containers. 150 mL of de-ionized water was poured in the bottom of the Tupperware containers and the fruits were sprayed with a light mist of water. The containers were brought to the lab, enclosed in a large trash bag to keep the humidity high, and incubated on a lab bench at approximately 23° C. The percentage of visual disease incidence and severity was assessed during the trial at 17 days after the first application. Results are given in Table 4.

Field Assessment of Podosphaera leucotricha (PODOLE) on Apples:

Assessment of compound I of PODOLE on apples was performed in two separate field trials. For the first trial, a fungicidal treatment containing a 5% EC formulation of compound I plus an adjuvant (ETHOMEEN T18H, 50% w/w at 1.0% v/v), was sprayed on the plant canopy of apples (MABSD, Imperatore Dallago variety) seven times during the growing season, the first application at BBCH 61 of plant growth stage, under natural infection of powdery mildew under open field conditions. The following six applications were applied in approximately 10 day intervals. Formulations of compound I were applied at rates of 100, 150, and 200 grams of active ingredient per hectare (g ai/ha). The treatment was part of an experimental trial designed as a randomized complete block with four replications and a plot of approximately 4.2×7.5 m. Formulations of compound I were applied at water volume of 800 L/ha, using a backpack plot sprayer (TRACKSP, Andreoli Engineering) and pressurized at 450 kPa.

For the second trial, a fungicidal treatment containing a 5% EC formulation of compound I plus an adjuvant (ETHOMEEN T18H, 50% w/w at 1.0% v/v), was sprayed on the plant canopy of apples (MABSD, Imperatore Dallago variety) seven times during the growing season, the first application at BBCH 61 of plant growth stage, under natural infection of powdery mildew under open field conditions. The following six applications were applied in approximately 10 day intervals. Formulations of compound I were applied at rates of 100, 150, and 200 grams of active ingredient per hectare (g ai/ha). The treatment was part of an experimental trial designed as a randomized complete block with four replications and a plot of approximately 4.2×7.5 m. Formulations of compound I were applied at water volume of 800 L/ha, using a self-propelled multi-plot track sprayer (TRACKSP, Andreoli Engineering) and pressurized at 450 kPa.

Disease severity in both trials was assessed as the percentage of leaf incidence and leaf infection on a random selection of 100 leaves. In the first trial, powdery mildew infection was assessed three times, 3 days after application D (3DAAD), 7DAAF, and SDAAG. In the second trial, powdery mildew infection was assessed four times, 6DAAB, 2DAAD, 7DAAF and SDAAG. Area under the disease progress curve (AUDPC) was calculated for each plot using the sets of recorded visual infection data. Relative AUDPC (% control based on AUDPC) was calculated as percent of the nontreated control. Results are given in Table 5.

Field Assessment of Alternaria mali (ALTEMA) on Apples:

Assessment of compound I on leaf spot of apple (ALTEMA), in both protectant and curative fashion, was performed in two separate field trials. For the protectant trial, a fungicidal treatment containing a 10% SC formulation of Compound I, either alone or with an adjuvant (Agnique BP420, 50% w/w at 0.3% v/v; or ETHOMEEN T18H, 50% w/w at 0.2% v/v), was sprayed on the plant canopy of apple trees (Hongxing variety) six times during the growing season of apples with each application coming at 15 day intervals. Formulations of Compound I, with or without adjuvants, were applied at rates of 100, 125 and 150 grams of active ingredient per hectare (g ai/ha) and were applied at water volume of 4500 L/ha. The experimental plots were inoculated three times with the leaf spot pathogen, the first inoculation performed at 2 days after the first application (Application A, 2DAAA), with the following applications at 2DAAC and 2DAAD. The treatment was part of an experimental trial designed as a randomized complete block with three replications and a plot size of 3 trees.

For the curative trial, a fungicidal treatment containing a 10% SC formulation of Compound I, either alone or with an adjuvant (Agnique BP420, 50% w/w at 0.3% v/v; or ETHOMEEN T18H, 50% w/w at 0.2% v/v), was sprayed on the plant canopy of apple trees (Hongxing variety) six times during the growing season of apples with each application coming at 15 day intervals. Formulations of Compound I, with or without adjuvants, were applied at rates of 100, 125 and 150 grams of active ingredient per hectare (g ai/ha) and were applied at water volume of 4500 L/ha. The experimental plots were inoculated three times with the leaf spot pathogen, the first inoculation performed at 5 days before the first application. The second inoculation was at 5 days before the third application and the third inoculation coming at 5 days before the fourth application. The treatment was part of an experimental trial designed as a randomized complete block with three replications and a plot size of 3 trees.

Disease incidence was assessed as percentage of diseased foliage per plant. Apple leaf spot infection was assessed six times, with the last assessment coming at 90 days after the first application. Area under the disease progress curve (AUDPC) was calculated for each plot using the sets of recorded visual infection data. Relative AUDPC (% control based on AUDPC) was calculated as percent of the nontreated control. Results are given in Table 6.

Field Assessment of Venturia pyrina (VENTPI) and Capnodium sp. (CAPDSP) on Pears:

A 10% SC formulation of Compound I was tank mixed with three different adjuvants: Agnique BP420 (50% w/w at 0.3% v/v), Ethomeen T18H (50% w/w at 0.15% v/v) and Trycol (50% w/w at 0.3% v/v). Formulations of compound I were sprayed on the plant canopy of pear trees (Highland variety) of approximately 2.5 m in height at rates of 100, 150 and 200 grams of active ingredient per hectare (g ai/ha). The trial was based on six foliar applications during the growing season at approximately 12 day intervals with natural pear scab and sooty mold infections in open field conditions. The treatment was part of an experimental trial designed as a randomized complete block with four replications and a plot of approximately 3×5 m. Formulations of compound I were applied with a SOLO mistblower sprayer at a water volume of 1500 L/ha.

For VENTPI evaluation, percent control was calculated based on incidence and severity in fruit assessment vs the nontreated control on a random selection of 50 fruits per plot. For CAPDSP assessment, percent control was calculated from percent leaf severity using Abbotts and the nontreated control. Percent control for both diseases was calculated at 11DAAE, 7DAAF and 15DAAF. Results are given in Table 7.

Field Assessment of Erysiphe necator (UNCINE) on Grapes:

A fungicidal treatment containing Compound I, applied in a 5% EC formulation and tank mixed with an adjuvant (Trycol, 50% w/w at 0.2% v/v), was sprayed on the plant canopy of grape plants (VITVI, Chardonnay variety) at rates of 50, 100 and 150 grams of active ingredient per hectare (g ai/ha). The trial was based on six foliar applications during the growing season at approximately 10 day intervals with natural infections in open field conditions. The treatment was part of an experimental trial designed as a randomized complete block with four replications and a plot of approximately 3.0×7.0 m. Formulations of compound I were applied at water volume of 1000 L/ha, using a self-propelled multi-plot track sprayer (TRACTAIR, Andreoli Engineering) and pressurized at 400 kPa.

Disease evaluations were recorded as percent of leaves and fruit with disease (incidence) and percent diseased area on leaves and fruit (severity, using 100 random leaves and fruit bunches. Grape powdery mildew was assessed three times, with the initial assessment at 2 days after the fourth application. Area under the disease progress curve (AUDPC) was calculated for each plot using the sets of recorded severity data. Relative AUDPC (% control based on AUDPC) was calculated as percent of the nontreated control. Results are given in Table 8.

Field Assessment of Botrytis cinerea (BOTRCI) on Strawberry and Grapevine:

On strawberry: A fungicidal treatment containing Compound I, applied in a 5% EC formulation and tank mixed with an adjuvant (Trycol, 50% w/w at 0.2% v/v), was sprayed on strawberry plants (FRAAN, Candonga variety) at rates of 50, 150 and 200 grams of active ingredient per hectare (g ai/ha). The trial was based on four broadcast applications during the growing season at approximately 10 day intervals with grey mold inoculation after the last application (plant growth stage B85). The treatment was part of an experimental trial designed as a randomized complete block with four replications and a plot size of approximately 2.0×5.0 m. Formulations of compound I were applied at water volume of 800 L/ha, using a backpack plot sprayer (BKPCKENG, solo 433; HCSOLID—Albutz ATR80 Yellow nozzle) and pressurized at 300 kPa.

Disease severity was recorded as a percentage of fruit incidence of damaged fruits on a random sample of 100 fruits per plot. Gray mold infection was assessed twice at 10 days after the third application (10DAAC) and 10DAAD. Area under the disease progress curve (AUDPC) was calculated for each plot using the sets of recorded incidence data. Relative AUDPC (% control based on AUDPC) was calculated as percent of the nontreated control. Results are given in Table 9.

Strawberry shelf-life simulation (3 repetitions): Fungicidal treatments were applied to strawberry plants grown in a shade house to obtain healthy fruits. Once matured, the healthy fruits were harvested and transferred to a laboratory for a shelf-simulation study. In the laboratory, the fruits were bleach decontaminated to remove residual chemical residue. Compound I, applied in a 5% EC formulation and mixed with an adjuvant (Trycol, 50% w/w at 0.2% v/v), was sprayed on the healthy strawberries at rates of 50, 100 and 150 grams of active ingredient per hectare (g ai/ha) and allowed to dry completely. The fruits were then inoculated with gray mold and incubated on a laboratory bench at 20° C.

Disease severity was recorded as a percentage of fruit infection assessments. Gray mold infection was assessed twice after the initial inoculation, 4 days after infection (4DAI) and 6DAI. Area under the disease progress curve (AUDPC) was calculated for each repetition using the sets of recorded severity data. Relative AUDPC (% control based on AUDPC) was calculated as percent of the nontreated control. Results are given in Table 9.

On grapevine: A fungicidal treatment containing Compound I, applied in a 5% EC formulation and tank mixed with an adjuvant (Trycol, 50% w/w at 0.2% v/v), was sprayed only on the bunch portion of grape plants (VITVI, Pinot grey variety) at rates of 50, 150 and 200 grams of active ingredient per hectare (g ai/ha). The trial was based on two applications 28 days apart in open field conditions with disease inoculation 3 days after the last application (plant growth stage B83). The treatment was part of an experimental trial designed as a randomized complete block with four replications and a plot of approximately 2.5×7.0 m. Formulations of compound I were applied at water volume of 500 L/ha (bunches only), using a backpack plot sprayer (AIRATOM, Solo 433; Airatom nozzle).

Disease severity was recorded as a percentage of incidence and infection of damaged bunches on a random sample of 100 bunches per plot. Gray mold infection was assessed three times, the first at 22 days after the last application (22DAAB), the second and third at 28DAAB and 36DAAB. Area under the disease progress curve (AUDPC) was calculated for each plot using the sets of recorded severity data. Relative AUDPC (% control based on AUDPC) was calculated as percent of the nontreated control. Results are given in Table 9.

Field Assessment of Mycosphaerella fijiensis (MYCOFI) on Banana:

Aliquots of a 5% EC formulation of compound I were diluted with water and mixed with Spraytex CT mineral oil (6 L CP/Ha) to achieve active ingredient rates of 25, 50, 100 and 150 g ai/Ha. These treatments were delivered to the foliar affected area of single leaves (application volume of 40 L/Ha) by means of an Aerograph spayer through a plastic molding with an application area of 9×12 centimeters. A single application was delivered to leaf 1 (preventive and very early curative), and leaf 3 (curative effect). Experimental design was based on a randomized complete block, and 4 replications. MYCOFI symptoms resulted from natural inoculation and epidemic development.

Percent disease control was calculated using the ratio of disease severity on treated leaves relative to untreated leaves. Black sigatoka infection was assessed five times during the trial: 31 days after application (31DAA), 38DAA, 45DAA, 52DAA and 59DAA. Area under the disease progress curve (AUDPC) was calculated for each plot using the sets of recorded severity data. Relative AUDPC (% control based on AUDPC) was calculated as percent of the nontreated control. Results are given in Tables 10 and 11.

In each case of Table 1-11 the rating scale of percent control based on AUDPC is as follows:

| % Control | Rating |
|---|---|
| 76-100 | A |
| 51-75 | B |
| 26-50 | C |
| 1-25 | D |
| Not tested | E |

TABLE 1
Efficacy of Compound I against Brown Rot of Flowers in
Stone Fruits (MONILA, Monilinia laxa) - Percent Control
Based on Area Under Disease Progression Curve (AUDPC)
from Flower Incidence Assessments on Field Grown Apricots

| | Compound I | | |
|---|---|---|---|
| | Grams of active | | |
| | ingredient per | | |
| | hectare (g ai/ha) | | |
| | 50 | 100 | 150 |
| % Control (AUDPC) | B | A | A |

TABLE 2
Efficacy of Compound I against Brown Rot in Stone Fruits
(MONIFC, Monilinia fructicola) at Harvest and Shelf Life
Simulation - Percent Control Based on Fruit Incidence
Assessments vs Untreated on Field Grown Nectarines

| | Compound I | | |
|---|---|---|---|
| | (g ai/ha) | | |
| | 50 | 100 | 150 |
| Harvest | B | B | B |
| Shelf Life Simulation | C | C | B |

TABLE 3
Efficacy of Compound I against Brown Rot (MONIFC,
Monilinia fructicola) and Rhizopus Rot (Rhizopus
stolonifer) in Stone Fruits - Percent Control Based on
Area Under Disease Progression Curve (AUDPC) from Fruit
Incidence Assessments on Field Grown Apricots

| | Compound I | | |
|---|---|---|---|
| | (g ai/ha) | | |
| | 50 | 100 | 150 |
| MONIFC | B | B | B |
| RIZPST | B | C | C |

TABLE 4
Efficacy of Compound I against Brown Rot (MONIFC, Monilinia
fructicola) and Rhizopus Rot (Rhizopus stolonifer) in Stone
Fruits - Expressed as Percent Severity and Incidence on
Field Grown Peaches

| | Compound I | | | Luna |
|---|---|---|---|---|
| | (g ai/ha) | | | Experience |
| | 50 | 100 | 150 | 240 |
| MONIFC^{a} | 87.3 | 57.0 | 69.5 | 58.5 |
| RIZPST^{b} | 67.5 | 22.5 | 35.0 | 20.0 |

^{a}Percentage of area affected on peaches (Severity)
^{b}Percentage of diseased peaches (Incidence)

TABLE 5
Efficacy of Compound I against Apple Powdery Mildew
(PODOLE, Podosphaera leucotricha) - Percent Control
Based on Area Under Disease Progression Curve (AUDPC)
from Leaf Infection Assessments

| | Compound I (g ai/ha) | | |
|---|---|---|---|
| | 100 | 150 | 200 |
| Trial 1 | B | A | A |
| Trial 2 | A | A | A |

TABLE 6
Efficacy of Compound I on Leaf Spot of Apple (ALTEMA,
Alternaria mali) in Protective and Curative Tests -
Percent Control Based on Area Under Disease Progression
Curve (AUDPC) from Leaf Infection Assessments

| Compound I | | % Control | % Control |
|---|---|---|---|
| (g ai/ha) | Adjuvant | Protectant | Curative |
| 100 | None | B | B |
| 100 | ETHOMEEN | A | A |
| 125 | ETHOMEEN | A | A |
| 125 | Agnique BP420 | A | A |
| 150 | ETHOMEEN | A | A |

TABLE 7
Efficacy of Compound I on Pear Scab (VENTPI, Venturia pyrina)
and Sooty Mold (CAPDSP, Capnodium sp.) - Percent Control
Based on Incidence and Severity in Fruit and Leaf Assessments
on Field Grown Pears 15 Days After Final Application

| Compound I | | | | |
|---|---|---|---|---|
| (g ai/ha) | Adjuvant | VENTPI^{a} | VENTPI^{b} | CAPDSP^{c} |
| 100 | None | C | B | A |
| 100 | ETHOMEEN | C | B | A |
| 100 | Agnique BP420 | B | B | A |
| 100 | Trycol | B | B | A |
| 100 | Agnique BP420 | B | A | A |
| 200 | Agnique BP420 | B | B | A |

^{a}Incidence in fruit assessement
^{b}Severity in fruit assessement
^{c}Incidence in leaf assessement

TABLE 8
Efficacy of Compound I against Grape Powdery Mildew
(UNCINE, Erysiphe necator) - Percent Control
Based on Area Under Disease Progression Curve (AUDPC)
from Leaf and Bunch Infection Assessments

| | Compound I (g ai/ha) | | |
|---|---|---|---|
| | 50 | 100 | 150 |
| Leaf | A | A | A |
| Bunch | B | B | A |

TABLE 9
Efficacy of Compound I on Gray Mold of Strawberries
and Grapevine (BOTRCI, Botrytis cinerea) - Percent
Control Based on Area Under Disease Progression Curve
(AUDPC) from Fruit Infection Assessments

Compound I (g ai/ha)

| | 50 | 100 | 150 | 200 |
|---|---|---|---|---|
| Strawberry | B | NT | A | A |
| Strawberry | B | A | A | NT |
| (Shelf life simualtion)^{a} | | | | |
| Grapevine | B | NT | A | A |

^{a}Percent control based on Area Under Disease Progression Curve (AUDPC) from fruit severity assessments

TABLE 10
Efficacy of Compound I on Black Sigatoka on Bananas
(MYCOFI, Mycosphaerella fijiensis) 52-59 Days After
Application - Expressed as Area Under Disease Progression
Curve (AUDPC) from Severity Assessments

| | | Compound I (g ai/ha) | | | |
|---|---|---|---|---|---|
| | Untreated | 25 | 50 | 100 | 150 |
| Leaf 1 (Preventive) | 665 | 198 | 211 | 203 | 183 |
| Leaf 3 (Curative) | 464 | 357 | 317 | 289 | 293 |

TABLE 11
Efficacy of Compound I on Black Sigatoka on Bananas (MYCOFI,
Mycosphaerella fijiensis) - Percent Control Calculated
from Severity Percentage 52 Days After Application

Compound I (g ai/ha)

| | 25 | 50 | 100 | 150 |
|---|---|---|---|---|
| Leaf 1 (Preventive) | B | B | B | B |
| Leaf 3 (Curative) | C | C | C | C |

Field Assessment of Podosphaera clandestina (PODOCL) in Cherry:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed on cherry trees (PRNAV, Sentennial variety) at growth stage (mid petal fall, flowers fading, petals falling; BBCH 67-85) at rates of 60, 120, 150, and 180 g ai/ha. The experimental plots were run with natural infestation. The treatment was part of an experimental trial designed as a randomized complete block (RCB) with four replications and a plot of approximately 4×6 m. Compound I was applied at water volume of 1000 L/ha, using an Airblast sprayer.

Disease severity (percentage of visual diseased foliage (leaf) on whole plot) and disease incidence were assessed 14 days after application 5 (14 DAA5). The disease infection was recorded. Disease was evaluated as percent of leaves with disease (incidence), percent diseased leaf area (severity, a disease index calculated (percent (%) incidence×percent (%) severity) and then percent (%) control was calculated using Abbotts from the disease index values. Results are given in Table 12.

Field Assessment of Two Trials for Cladosporium caryigenum (CLADCA) in Pecan:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed on pecan trees (CYAIL, Desirable variety) from pre-flowering up to nut hardening at rates of 60, 120, 150, and 180 g ai/ha. The experimental plots were run with natural infestation. The treatment was part of an experimental trial designed as a randomized complete block (RCB) with four replications and a plot of approximately 40×40 ft, respectively. In one test, compound I was applied in 9 applications at water volume of 94-115 gallons per acre (gal/acre), using an Airblast sprayer (Hollowcone solid disc D10/45 nozzles) and pressurized at 46-54 psi. In the second test, compound I was applied in 8 applications at water volume of gal/acre, using a Handgun sprayer (solid stream nozzle) and pressurized at 300 psi. Both trials targeted 14 day intervals for applications.

Disease evaluations were made as % incidence and % severity nuts in one test, 3 evaluations each, 9 applications, and as % incidence nuts and % severity leaves in the second test, 2 and 3 evaluations, respectively, 8 applications. Area under the disease progress curve (AUDPC) was calculated for each plot using the sets of recorded severity and incidence data. Relative AUDPC (% control based on AUDPC) was calculated as percent of the untreated control. Results are given in Table 13.

Field Assessment of Cladosporium carpopilum (CLADSP) in Almond:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed as a single application on almond trees (PRNDU, Winter variety) at rates of 60, 120, 150, and 180 g ai/ha. The experimental plots were run with natural infestation. The treatment was part of an experimental trial designed as a randomized complete block (RCB) with three replications and a plot of approximately 16×22 ft. Compound I was applied at water volume of 100 gal/acre, using a Mistblower sprayer (Orifice nozzle 2.3 setting).

Nut incidence (number of visual diseased nuts per 10 nuts per tree on whole plot) was assessed 121 days after application A (121 DAAA). Using Abbotts, % nut incidence of the treatments was used vs the nontreated to calculate % control. Results are given in Table 14.

Field Assessment of Stigmina carpophila (STIGCA) in Almond:

A fungicidal treatment containing Compound I, applied in an SC formulation (MSO built-in) and tank mixed with an adjuvant (Adsee C80W 80%), was sprayed on almond trees (PRNDU, Butte variety), 2 applications, at growth stages BBCH67 and 72 at rates of 60, 120, 150, and 180 g ai/ha. The experimental plots were run under natural infestation. The treatment was part of an experimental trial designed as a randomized complete block (RCB) with three replications and a plot of approximately 16×22 ft. Compound I was applied at water volume of 100 gal/acre, using a motorized backpack sprayer (Orifice nozzle 2.3 setting).

Leaf incidence (number of visual diseased leaves per 20 leaves per tree on the whole plot) was assessed 121 days after application A (121 DAAA). Results are given in Table 15.

Nut incidence (number of visual diseased nuts per 10 nuts per tree on the whole plot) was assessed 121 days after application A (121 DAAA). Results are given in Table 16.

Field Assessment of Two Trials for Stigmina carpophila (STIGCA) in Almond:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed on almond trees (PRNDU, Winters or Carmel varieties) at growth stage BBCH71 and 72 at rates of 60, 120, 150, and 180 g ai/ha in two trials. The experimental plots were run with natural infestation. The treatments were part of experimental trials designed as a randomized complete block (RCB) with three replications and a plot of approximately 14×20 ft, both trials. Compound I was applied at water volume of 100 gal/acre, using a Mistblower sprayer (Orifice nozzle 0.125 setting), both trials.

Percent Leaf incidence (calculated from the number of visual diseased leaves per 30 (Winters) or 50 (Carmel) leaves per tree on whole plot) was assessed three or four times during the trial. Area under the disease progress curve (AUDPC) was calculated for each plot using the sets of recorded leaf incidence data. Relative percent control was calculated from the AUDPC as percent of the untreated control using Abbotts. Results are given in Table 17.

Field Assessment of Tranzschelia discolor (TRANDI) in Almond:

A fungicidal treatment containing Compound I, applied in an SC formulation (MSO-buit in) and tank mixed with an adjuvant (Adsee C80W 80%), was sprayed on almond trees (PRNDU, Butte variety) with 2 applications at growth stages BBCH67-69 and BBCH69-72 at rates of 60, 120, 150, and 180 g ai/ha. The experimental plots were run under natural infestation. The treatments were part of an experimental trial designed as a randomized complete block (RCB) with three replications and a plot of approximately 16×22 ft. Compound I was applied at water volume of 100 gal/acre, using a motorized backpack sprayer.

Percent leaf incidence (calculated from number of visual diseased leaves per 50 leaves per one tree) was assessed and recorded at 105 days after application A (105 DAAA). Results are given in Table 18.

Field Assessment of Botrytis (BOTRSP) in Almond:

A fungicidal treatment containing Compound I, applied in an SC formulation (MSO-built in) was sprayed on almond trees (Prunus spp.) at bloom, petal fall and ca. 3 and 5 weeks after petal fall at rates of 60, 120, 150, and 180 g ai/ha. The experimental plots were conducted with a natural infestation of Botrytis. The treatments were part of an experimental trial designed as a randomized complete block (RCB) with three replications and a plot of approximately 18×18 ft. Compound I was applied at water volume of 100 gal/acre, using an Airblast sprayer.

Nut infection (number of visual diseased nuts per total nuts counted per tree on whole plot) was assessed and recorded 17 days after application 4 (17 DAA4). Relative percent control was calculated as percent of the untreated control using Abbotts. Results are given in Table 19.

TABLE 12
Efficacy of Compound I on Powdery Mildew of Cherry (PODOCL,
Podosphaera clandestina) - Calculated Percent Control
of PODOCL on Leaves 14 Days after Application (14 DAA5)

| | | Calc Percent Control |
|---|---|---|
| Compound I^{a} | Adjuvant | of PODOCL |
| 60 | MSO, 120^{a} | 63.3 |
| 120 | MSO, 240^{a} | 37.9 |
| 150 | MSO, 300^{a} | 91.7 |
| 180 | MSO, 360^{a} | 89.1 |
| 60 | Agnique BP420, 240 ^{b} | 64.6 |
| 120 | Agnique BP420, 480 ^{b} | 46.9 |
| 150 | Agnique BP420, 600 ^{b} | 44.4 |
| 180 | Agnique BP420, 720 ^{b} | 48.7 |
| 120 | Adsee C80W 80%, 300^{a} | 44.4 |
| Untreated | | 0 |

^{a}rate in g ai/ha
^{b} rate in mL/ha

TABLE 13
Efficacy of Compound I on Pecan Nut Scab (CLADCA,
Cladosporium caryigenum) - Calculated Percent Control of CLADCA

| | | Calc Percent Control |
|---|---|---|
| Compound I^{a} | Adjuvant | of CLADCA (AUDPC) |
| 60 | MSO, 120^{a} | 29.8 |
| 120 | MSO, 240^{a} | 30.1 |
| 150 | MSO, 300^{a} | 29.8 |
| 180 | MSO, 360^{a} | 53.0 |
| 60 | Agnique BP420, 240 ^{b} | 25.1 |
| 120 | Agnique BP420, 480 ^{b} | 28.8 |
| 150 | Agnique BP420, 600 ^{b} | 35.0 |
| 180 | Agnique BP420, 720 ^{b} | 32.5 |
| 120 | Adsee C80W 80%, 300^{a} | 21.9 |

^{a}rate in g ai/ha
^{b} rate in mL/ha

TABLE 14
Efficacy of Compound I on Almond Scab (CLADSP,
Cladosporium carpopilum) - Calculated Percent Control of CLADSP

| | | Calc Percent Control |
|---|---|---|
| Compound I^{a} | Adjuvant | of CLADSP |
| 60 | MSO, 120^{a} | 61.8 |
| 120 | MSO, 240^{a} | 97.0 |
| 150 | MSO, 300^{a} | 55.1 |
| 180 | MSO, 360^{a} | 39.5 |
| 60 | Agnique BP420, 240 ^{b} | 47.3 |
| 120 | Agnique BP420, 480 ^{b} | 68.2 |
| 150 | Agnique BP420, 600 ^{b} | 69.7 |
| 180 | Agnique BP420, 720 ^{b} | 90.9 |

^{a}rate in g ai/ha
^{b} rate in mL/ha

TABLE 15
Efficacy of Compound I on Shot Hole (STIGCA, Stigmina carpophila)
in Almond - Leaf Incidence (Number of Leaves per 20 Leaves)
of STIGCA 105 Days after Application B (121 DAAA)

| | | Leaf Incidence of |
|---|---|---|
| Compound I^{a} | Adjuvant | STIGCA 121 DAAA |
| 60 | MSO, 120^{a} | 3.0 |
| 120 | MSO, 240^{a} | 2.2 |
| 150 | MSO, 300^{a} | 1.7 |
| 180 | MSO, 360^{a} | 1.9 |
| 120 | Adsee C80W, 300^{a} | 1.4 |
| Untreated | | 3.1 |

^{a}rate in g ai/ha

TABLE 16
Efficacy of Compound I on Shot Hole (STIGCA, Stigmina carpophila)
in Almond - Nut Incidence (Number of Nuts per 10 Nuts) of
STIGCA 105 Days after Application B (121 DAAA)

| | | Nut Incidence of |
|---|---|---|
| Compound I^{a} | Adjuvant | STIGCA 121 DAAA |
| 60 | MSO, 120^{a} | 5.6 |
| 120 | MSO, 240^{a} | 6.0 |
| 150 | MSO, 300^{a} | 4.4 |
| 180 | MSO, 360^{a} | 4.4 |
| 120 | Adsee C80W, 300^{a} | 2.5 |
| Untreated | | 6.3 |

^{a}rate in g ai/ha

TABLE 17
Efficacy of Compound I on Shot Hole (STIGCA, Stigmina carpophila)
in Almond - Calculated Percent Control (AUDPC) of STIGCA

| | | Calculated Percent |
|---|---|---|
| | | Control (AUDPC) of |
| Compound I^{a} | Adjuvant | STIGCA |
| 60 | MSO, 120^{a} | 47.9 |
| 120 | MSO, 240^{a} | 48.3 |
| 150 | MSO, 300^{a} | 45.1 |
| 180 | MSO, 360^{a} | 49.0 |
| 60 | Agnique BP420, 240 ^{b} | 45.2 |
| 120 | Agnique BP420, 480 ^{b} | 49 |
| 150 | Agnique BP420, 600 ^{b} | 41.1 |
| 180 | Agnique BP420, 720 ^{b} | 30.1 |
| 120 | Adsee C80W, 300^{a} | 44.6 |

^{a}rate in g ai/ha
^{b} rate in mL/ha

TABLE 18
Efficacy of Compound I on Rust (TRANDI,
Tranzschelia discolor) in Almond - Percent Visual Leaf
Incidence of TRANDI 89 Days after Application B (89 DAAB)

| | | Percent Visual Leaf |
|---|---|---|
| | | Incidence of |
| Compound I^{a} | Adjuvant | TRANDI 89 DAAB |
| 60 | MSO, 120^{a} | 13.3 |
| 120 | MSO, 240^{a} | 9.3 |
| 150 | MSO, 300^{a} | 6.0 |
| 180 | MSO, 360^{a} | 6.0 |
| 120 | Adsee C80W, 300^{a} | 11.3 |
| Untreated | | 61.3 |

^{a}rate in g ai/ha

TABLE 19
Efficacy of Compound I on Jacket Rot (BOTRSP, Botrytis, Rhizopus,
and Monolinia) in Almond - Calculated Percent Control
of BOTRSP 17 Days after Application 4 (17 DAAD)

| | | Calc Percent Control |
|---|---|---|
| Compound I^{a} | Adjuvant | of BOTRSP 17 DAA4 |
| 60 | MSO, 120^{a} | 37.9 |
| 120 | MSO, 240^{a} | 40.0 |
| 150 | MSO, 300^{a} | 51.6 |
| 180 | MSO, 360^{a} | 53.5 |

^{a}rate in g ai/ha

What is claimed is:

1. A method of controlling fungal diseases in orchard, vineyard and plantation crops that are at risk of being diseased comprising the steps of: contacting at least a portion of a plant and/or an area adjacent to a plant with a composition including compound I. 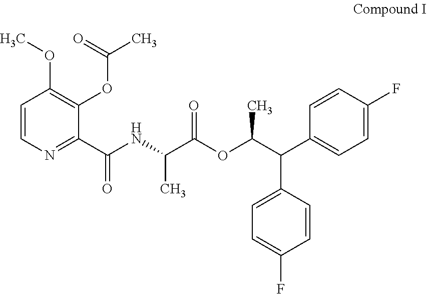 [SMILES: COc1ccnc(C(=O)N[C@@H](C)C(=O)O[C@@H](C)C(c2ccc(F)cc2)c2ccc(F)cc2)c1OC(C)=O]
wherein said compound is effective against a plant pathogen.

2. The method of claim 1 wherein the composition is

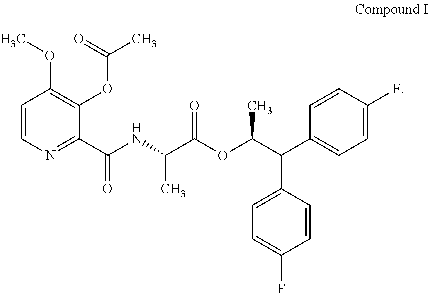 [SMILES: COc1ccnc(C(=O)N[C@@H](C)C(=O)O[C@@H](C)C(c2ccc(F)cc2)c2ccc(F)cc2)c1OC(C)=O]

3. The method of claim 1, wherein the composition further includes at least one of one additional agriculturally active ingredient selected from the group consisting of: an insecticide, an herbicide, and a fungicide.

4. The method of claim 1, wherein the fungal pathogen is selected from the group consisting of the causal agents of: brown rot in flowers and fruits of stone fruits (Monilinia laxa and Monilinia fructicola), fruit rot in stone fruits (Rhizopus stolonifer), powdery mildew of apples (Podosphaera leucotricha), leaf spot of apples (Alternaria mali), scab of pear (Venturia pyrina), sooty mold of pear (Capnodium sp.), powdery mildew of grape (Erysiphe necator), gray mold of strawberry and grapevine (Botrytis cinerea), black sigatoka of bananas (Mycosphaerella fijiensis), powdery mildew of cherry (Podosphaera clandestina, PODOCL), pecan scab (Cladosporium caryigenum, CLADCA), almond scab (Cladosporium carpopilum, CLADSP), shot hole in almond (Stigmina carpophila, STIGCA), rust (Tranzschelia discolor, TRANDI), and jacket rot in almond (Botrytis, Rhizopus, and Monolinia).

5. The method of claim 2, wherein the composition further includes at least one of one additional agriculturally active ingredient selected from the group consisting of: an insecticide, an herbicide, and a fungicide.

6. The method of claim 2, wherein the fungal pathogen is selected from the group consisting of the causal agents of: brown rot in flowers and fruits of stone fruits (Monilinia laxa and Monilinia fructicola), fruit rot in stone fruits (Rhizopus stolonifera), powdery mildew of apples (Podosphaera leucotricha), leaf spot of apples (Alternaria mali), scab of pear (Venturiapyrina), sooty mold of pear (Capnodium sp.), powdery mildew of grape (Erysiphe necator), gray mold of strawberry and grapevine (Botrytis cinerea), black sigatoka of bananas (Mycosphaerella fijiensis), powdery mildew of cherry (Podosphaera clandestina, PODOCL), pecan scab (Cladosporium caryigenum, CLADCA), almond scab (Cladosporium carpopilum, CLADSP), shot hole in almond (Stigmina carpophila, STIGCA), rust (Tranzschelia discolor, TRANDI), and jacket rot in almond (Botrytis, Rhizopus, and Monolinia).
